(19) United States
(12) Patent Application Publication
(10) Pub. No.: US 2013/0149489 A1
(43) Pub. Date: Jun. 13, 2013

(54) CERAMIC ELEMENT

(71) Applicants: Winfried Schmidt, Wassertruding (DE); Jürgen Danner, Muhr am See (DE)

(72) Inventors: Winfried Schmidt, Wassertruding (DE); Jürgen Danner, Muhr am See (DE)

(73) Assignee: OECHSLER AKTIENGESELLSCHAFT, Ansbach (DE)

(21) Appl. No.: 13/516,825

(22) PCT Filed: Nov. 19, 2010
(86) PCT No.: PCT/EP2010/007034

§ 371 Date: Aug. 30, 2012

(30) Foreign Application Priority Data
Dec. 18, 2009 (DE) 10 2009 058 980.5

(51) Int. Cl. B32B 7/08

(52) U.S. Cl. CPC B32B 7/08
USPC 428/100; 428/99

(57) ABSTRACT

In order to ensure that upon destruction of a brittle article, in particular such as a ceramics element in the form of a frame receiving an apparatus, if possible no free fragments at all become detached therefrom, according to the invention the frame itself or a plate that is integrally moulded therewith and extends over the frame opening remote from view behind the apparatus is non-positively or positively connected at discrete points or in continuous segments in different regions to a connecting part injection-moulded from tough-elastic material. In turn, the connecting part can simultaneously be configured for detachably fastening the ceramics element to the apparatus or to an alternative construction part.

Decorative design or handling elements on high-end consumer goods, such as in motor vehicles or on handheld telecommunication devices, that have until now been injection molded from high-quality plastic are increasingly being replaced by ceramic elements that look and feel even more refined. This applies in particular to applications for dashboard coverings, operating controls or cellphone housing shells. Such ceramic elements are usually created by powder injection molding, in the case of more simple geometrical forms also by pressing; however, the elements may also be ceramic blanks, which are then given their final form by machining.

The configurational adaptation of such ceramic applications on the one hand to the surrounding design and on the other hand to a carrying structural part in the surrounding installation area thereof or to the handling requirements and configuration of a device often require complex geometries with surfaces that are usually irregularly curved on the visible side, with numerous projections and indentations on the rear side according to the local mounting specifications. For practical needs, the dimensional stability of such complexly configured, injection-molded or pressed ceramic elements is particularly problematical, especially since the green compacts injection-molded for instance from plastic that is filled with a high proportion of ceramic powder shrink by the order of 30% during the subsequent stages of the process of thermal debinding and sintering. It is therefore virtually impossible in series production to make particularly injection-molded ceramic elements of a complicated shaping to a similar exact fit as conventional plastics injection-molding elements used instead in the same place.

In addition, in the structural design of decorative ceramic elements it must be taken into consideration that, owing to its consistency, plastic tends to desirably have a shock-absorbing effect, whereas ceramic on the other hand, as a harder and heavier material, reacts more sensitively to mechanical shock loading, with significant noise. Therefore, simply exchanging a plastic element for a ceramic element that is comparatively configured but necessarily has greater tolerances can, depending on its dimensional stability and clear distance from the surrounding installation area, have the effect that mechanical vibrations cause the development of noise that would be unacceptable, at least for premium consumer goods. Therefore, in spite of the problems in terms of dimensional stability, on the other hand it is not possible in principle in the case of ceramic constructions for any play with respect to the surrounding installation area to be allowed - whereas no comparable problems occur in the case of plastic constructions.

Added to this is the safety problem that, on account of their brittle material, ceramic elements are not particularly impact resistant and therefore, under mechanical shock loading, can shatter into multiple fragments, which then possibly give rise to risks of injury to an operator in the form of cuts.

It consequently has nothing to do with first also arranging, as per DE 10 2004 019 111 A1, on the free extreme end of a swanneck mounting, in front of the holding plate thereof for an electronic device, an element with a downwardly projecting supporting bracket, which is intended in particular to prevent the device from being lowered too far by setting down on the dashboard of a motor vehicle. The holding plate is provided with interlocking fastening means for the device. The element inserted between the holding plate and the device has the same fastening means, so that a number of such elements can also be placed one on top of the other. The device is optionally either carried by the holding plate directly or else with at least one such element interposed.

The field outlined by contrast at the beginning is where we find the subject matter of DE 10 2006 007 271 A1, which relates in particular to a thin plate-shaped decorative ceramic element of pyrolyzable wood. Such a ceramic element, provided with predetermined breaking points, is adhesively attached in a surface-covering manner onto an elastic shatterproof layer and then mounted by means of the latter on a carrier serving as a supporting structure, which for its part can be fastened in an interlocking manner on a carrying structural part, serving for instance for operator control. It is alternatively shown that the ceramic element can be pushed directly into a T groove on the surface of a carrier structure. However, the latter may be unpractical for practical needs, that is because of the shrinkage-dependently only moderate dimensional stability of such ceramic elements that are to be held in the T groove without any play. On the other hand, the shatterproof layer adhesively attached to the carrier under the ceramic element causes logistical problems with regard to parts to be additionally mounted, and in particular the production disruptions feared in series production that are regularly caused by adhesively bonded connections as a result of clogged discharge nozzles; quite apart from the problems concerning the aging characteristics of adhesively bonded connections.

In the knowledge of such circumstances, the present invention addresses the technical problem of designing ceramic elements of the type discussed at the beginning particularly in such a way as to eliminate the risk of injury from cuts in the event of mechanical destruction of a particularly U- or O-frame-shaped ceramic element, especially also without additional surface-covering adhesive bonds that are critical to production; it being intended at the same time in the case of a stationarily fitted ceramic element that the mechanical stresses thereof, resulting from vibrational excitations, and consequent noise can be kept under control.

This problem is solved according to the invention by the features of the main claim. Accordingly, mechanical cohesion of at least relatively large fragments of a destroyed ceramic element is provided by the structural, particularly frictionally engaging, anchorages thereof on non-ceramic connecting parts. They are in engagement with ceramic fastening regions, which are integrally formed on partial regions of the ceramic element. Such a connecting part is preferably injection-molded from tough-elastic materials. Concealed or facing away from view, it is frictionally or interlockingly connected in a puntiform or linear manner to various regions at the same time of the preferably open- or closed-frame-shaped ceramic element by way of the integral fastening regions thereof integrally formed on regions of the frame. If the for instance ceramic element should happen to be destroyed, fragments thereof do indeed then remain coupled to one another by way of the fastening regions thereof and the connecting part bridging them. Thus, the fragments bound by way of their fastening regions to the at least one connecting part cannot fly about in an uncontrolled manner and, as a result, can also no longer cause injuries in the form of cuts.

The connecting part for its part can at the same time anchor the ceramic element, or if applicable fragments thereof, in a frictional or interlocking manner on a carrying stationary structural part or on a mobile device.

For interlocking connection of the connecting part to the fastening regions that are integrally formed on the various regions of the ceramic element, formed thereon are pins or grooves, and particularly holes, with which corresponding configurations on the connecting part can be brought into interlocking or simply frictional engagement. Thus, the fragments of a destroyed ceramic element still remain held together in certain regions by puntiform connection to the elastic, preferably tough-elastic connecting part, instead of shattering into parts that fly about freely.

Especially whenever the geometry of the ceramic element does not give reason to expect such structurally relatively defined fragments that are few in number and allow themselves to be used for puntiform anchorages on fastening regions, it is more advantageous to form, at least in certain regions, again away from view, a profiled groove which extends as a fastening region on the ceramic element and into which the connecting part engages with a rib-shaped bead of a corresponding cross-sectional geometry. This dispenses with the need for a large number of individual anchorage points for the connecting part in regions of the ceramic element that give no reason to expect larger fragments on account of their geometry.

The ceramic element together with its fastening regions is more expediently divided by predetermined breaking points into mutually offset regions, to which the connecting part is respectively connected. Such predetermined breaking points may be incorporated in the structural design in their own right, or result already from other structural requirements. Such weak points or predetermined breaking points that are useful for the safety function within the scope of the present invention inevitably result for example from fastening regions for the engagement of the connecting part being integrally formed at the corners and end faces of an o-shaped or u-shaped frame. Thus, these corner regions, anchored on at least one connecting part, are mechanically more stable per se than the longitudinal and transverse sides extending between the corners, and having comparatively small cross sections, of a closed frame or the limbs of a frame that is open in the form of a u. Broken-off regions of the frame remain bound to their fastening regions, integrally formed in respectively neighboring corner regions of the ceramic frame, and thereby to the connecting part.

In the case of a frame-shaped ceramic element, the opening thereof can be bridged, particularly in part or even over the full surface area, by a panel-shaped fastening region extending between the sides or limbs of the frame. In order to avoid steep steps in the material on the ceramic frame, a thickness of such an integrally formed ceramic panel up to the order of magnitude of the thickness of the frame should be aimed for, but can rarely be realized for reasons of space. If required, the fastening panel could on the other hand also be designed to be very thin, for instance in the manner of a simple piece of flash that spans the opening surrounding the ceramic frame between regions of the limbs or sides of the frame below the visible plane of the frame. Above such a panel, the device to be covered by the ceramic element may be pushed in between the limbs of the frame or lowered between the sides of the frame.

The geometry of the connecting part in engagement with various fastening regions depends for its part on the configuration and the fitting out of the ceramic element and similarly on the neighboring shaping of the device or carrying structural part. The ceramic element may for instance have a frame-shaped opening for receiving the display or the keypad of a device. The at least one connecting part situated behind said opening may, like the fastening panel, span the opening in the frame in the manner of a mesh or plate or, for example, only surround it in the form of an annular strip; to be precise between the device and the panel, but preferably behind the panel and consequently toward the rear in the frame. By analogy with the panel, the connecting part is also provided with engaging structures such as pins or holes. Preferably, pins provided on the connecting part enter into frictional or interlocking engagement with geometrically corresponding holes in fastening regions of the ceramic element when the ceramic element is fitted out with the at least one connecting part. If this connecting part also engages with pins in the device framed by the ceramic element, at the same time secure fixing of the frame to the device is thereby ensured.

Moreover, the connecting part is preferably designed with regard to choice of material and three-dimensional shaping for elastic support with at the same time mechanical damping of the ceramic element with respect to the surrounding installation area - expediently while maintaining a small clear distance between the ceramic element and its surrounding installation area, which makes the dimensional stability of the ceramic element less critical in a desirable way, without leading to vibrational noises on the device covered therewith. This is so because dimensional tolerances of the ceramic element are bridged by this stiff-elastic, spacing damping compound, whereby the desirable mechanical noise isolation is also achieved.

Additional alternatives and developments within the scope of the present invention are provided by the further claims and, also with regard to advantages thereof, by the following description of preferred exemplary embodiments of the solution according to the invention, which are outlined in a greatly simplified and not-to-scale form in the drawing, in which:

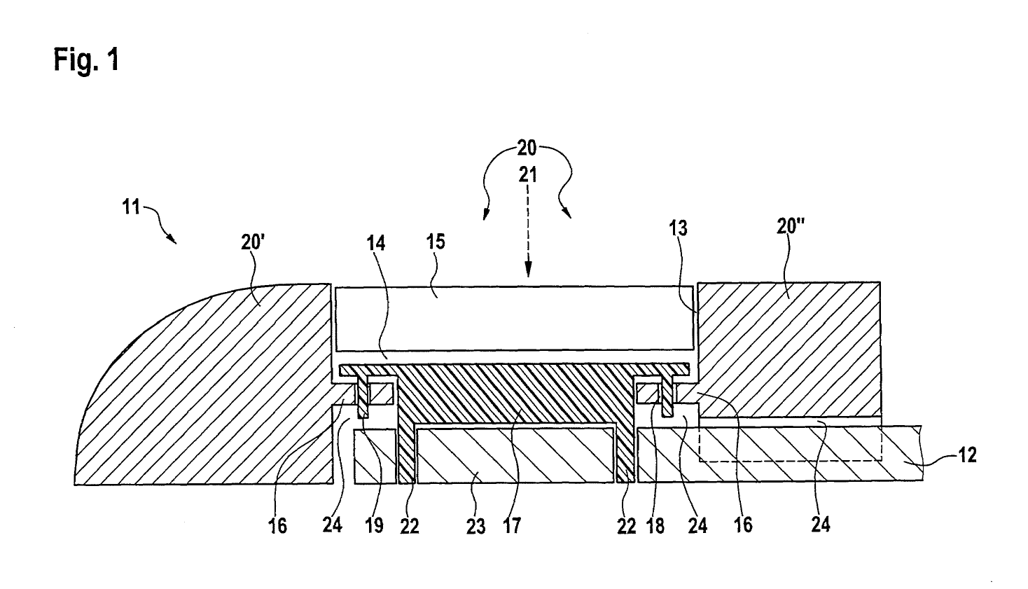

FIG. 1 shows in longitudinal section an o-frame-shaped ceramic element which is fitted out with a display and carried by a stationary structural part, and to the lug-like integrally formed fastening regions of which a connecting part is connected;

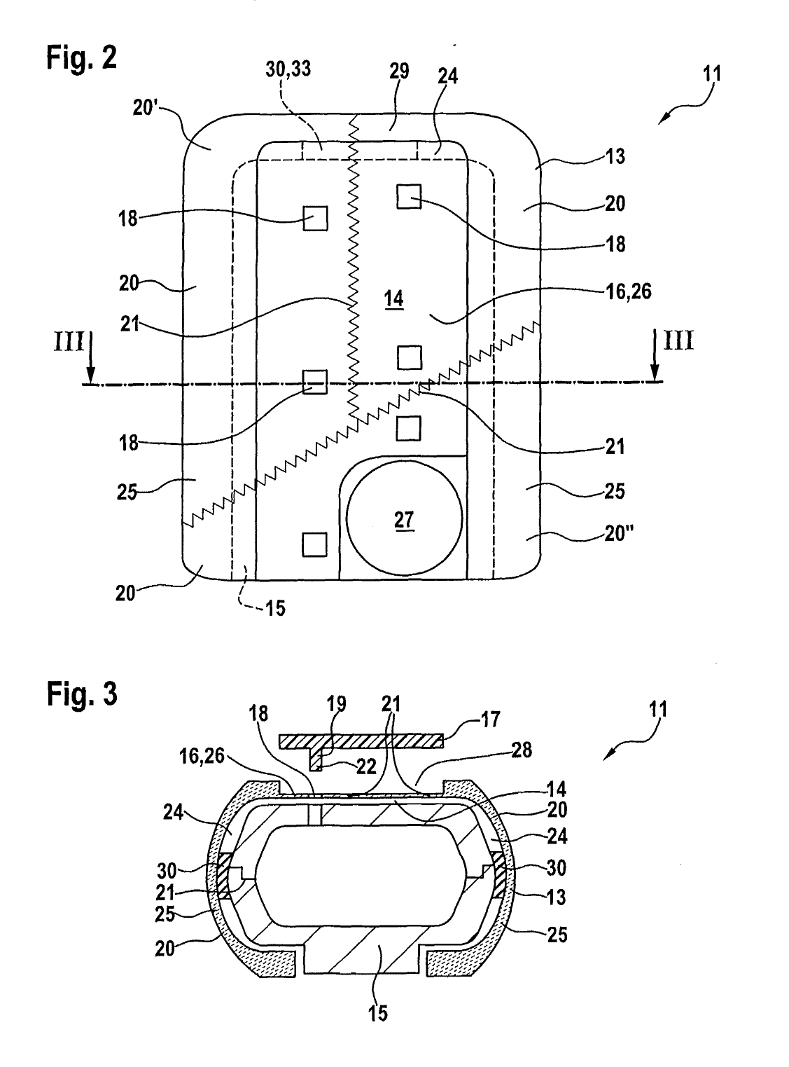

FIG. 2 shows in a rear view a u-frame-shaped ceramic element, the opening of which between the limbs thereof is bridged by a thin wall as a fastening region, in front of which a handheld device such as a remote control has been lowered into the ceramic frame,

FIG. 3 shows the device with the applied frame that is shown in FIG. 2 in cross section with a connecting part to be inserted rearwardly into the frame, and

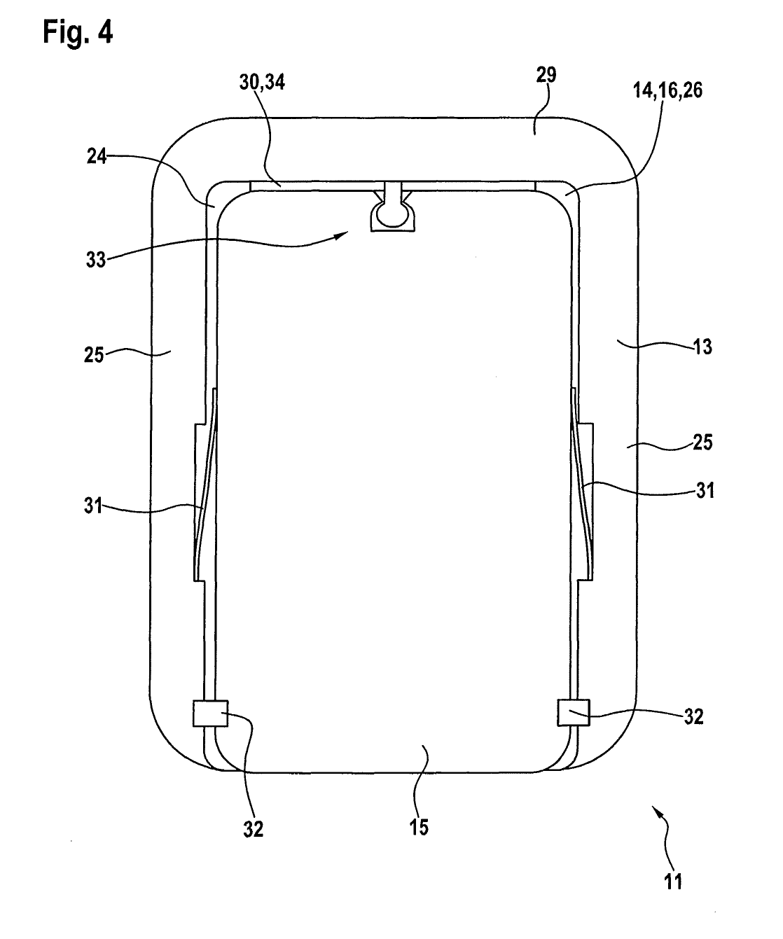

FIG. 4 shows as a basic diagram preferred latching possibilities directly between the frame and the device fitting thereof from the visible side.

The outlined, in particular injection-molded or compression-molded ceramic element 11 lies in FIG. 1 at the free end of an operating control 12 stationarily installed, for instance in a vehicle or in some other apparatus. An opening 14 in the ceramic element 11 that is surrounded by a frame 13 running around continuously serves for receiving a device 15, which can be lowered into the opening 14 and secured therein in a material-bonding, interlocking or frictional manner and has an accessory, for instance of the nature of an electrooptical display or a pushbutton remote control.

Under the lower plane of the device 15, fastening regions 16 that are integrally formed on the ceramic element 11 and are provided with projecting pins, but preferably as outlined with holes 18, protrude into the opening 14. Said regions serve for anchoring a connecting part 17 placed into the opening 14, here for example a cuboidal connecting part, which is preferably injection-molded from tough-elastic plastic. For frictional or interlocking connection to the fastening regions 16, the connecting part 17 has, as outlined, downwardly directed pins 19, corresponding to the holes in the fastening regions 16. Thus, by simply pressing into the opening 14 toward the fastening regions 16, the connecting part 17 is reliably connected to all the regions 20 (20′, 20″) of the frame-shaped ceramic element 11 that could, for instance in the event of a hard collision with a foreign body, otherwise fly about as free fragments.

It is therefore possible to preordain a fragment pattern by individual regions 20 (20′, 20″) that are connected to the connecting part 17 being delimited from one another in a defined manner by predetermined breaking points 21 in the ceramic element 11 that are caused by the structural design or specifically specified, for instance in the form of local cross-sectional reductions of the frame 13. This arises already in the shape of the frame profile regions 20 that are reduced in comparison with the frame corners with their fastening regions 16, otherwise for instance by predetermined breaking points 21 that are formed into the frame 13 in their own right.

The drawing does not allow for the possibility that, for mounting the connecting part 17, instead of the outlined hole-pin connections, or in addition thereto, grooves or ribs may also be formed on fastening regions 16, or directly in the inner wall of the frame 13, in order to be brought into contact with corresponding cross sections on the connecting part 17. As a result, it is no longer the case there that individual regions of the ceramic element 11 are connected to the connecting part 17 at a distance from one another in a puntiform manner, but now virtually uninterruptedly in a linear form.

The connecting part 17, which is substantially plate-shaped here, is for its part expediently configured with integrally formed fastening means 22 for the mounting that is only symbolically illustrated in the drawing on a carrying structural part 23, such as here on the end region of the control 12. The mounting may be performed in a material-bonding, frictional or interlocking manner by means of such fastening means 22, for instance by clasp-like or, as outlined, pin-like projections for fitting on or by means of through-holes for screwing onto the structural part 23 at the bottom of the opening 14.

The thickness of the stiff-elastic connecting part 17, and if applicable the length of its fastening means 22, are preferably dimensioned in such a way that a slight clear distance 24 remains between the ceramic element and its carrying structural part 23, as far as possible out of sight. As a result, dimensional tolerances caused by the shrinkage during the heat treatment of the ceramic element 11 are masked and mechanical stresses and acoustic disturbances arising from vibrational contact of the ceramic element 11 with its carrying structural part 23 are avoided.

In the case of the exemplary embodiments, likewise according to the invention, that are shown in FIG. 2 to FIG. 4, a device 15, for instance again with a display or with a pushbutton arrangement of a mobile remote control, such as in the form of a key for a motor vehicle, has in each case been pushed in between the limbs 25 of the ceramic element 11 of a ceramic frame 13 that is now open in the form of a u. Facing away from view behind the device 15 there extends as a closed fastening region 16 over as large a region as possible of the opening 14, between regions of the limbs 13-13 that are formed in one piece therewith, a panel 26 that is very thin here, designed like a piece of flash, which if need be is cut out, as shown behind the battery holder 27. This fastening panel 26, integrally formed on the individual frame regions 20, extends in a plane situated between the surfaces of the frame 13 on both sides, so that a now thin-plate-shaped connecting part 17 preferably does not rest on the back of the frame 13, but can be placed in a rear depression 28 in the frame 13. In this case, pins 19 projecting forward from the connecting part 17 engage in a frictional manner in holes 18, which have been cut out or machined in the ceramic panel 26 so as to be accessible from the rear. As a result, virtually all the regions 20 of the frame 13 remain bound to the connecting part 17, which in comparison with the ceramic is elastic, by way of the integral panel 26 spanning the opening 14 of said frame behind the device 15, especially if the ceramic frame 13 should happen to shatter into individual regions 20 along predetermined breaking points 21 extending into this wall 26.

The holes 18 are preferably not closed in the form of blind holes but, as outlined, pass through and the pins 19 are dimensioned to be of such a length that the latter also engage as fastening means 22 through the panel 26 in an interlocking or frictional manner into the device 15 secured in the frame 13 in front of the panel 26. As a result, the U frame 13 pushed onto the device 15 is reliably anchored on the device 15—with the possibility of detachment after taking out the connecting part 17 rearwardly from the fastening regions 16.

In FIG. 2 on the inner side of the U yoke 29 and in FIG. 3 on the outer sides of the U limbs 25 of the ceramic frame 13, tough-elastic damping compounds 30 have been introduced into the frame 13, in order to bridge in a shock-absorbing and noise-isolating manner the radial distances between the production-dependent oversize of the ceramic element 11 and the device 15 received therein.

Instead of the anchorage between the ceramic element 11 and the device 15 by way of the fastening means 22 of the connecting part 17, or in addition thereto, further expedient realizations are outlined in FIG. 4. Thus, for re-releasable latching, at least one resilient tongue 31 that is placed in or else fixedly mounted at one end, in particular fixed to the device, may be provided between the ceramic element 11 and the device 15, for instance in front of the panel 26 behind the device 15 or, as outlined, at the inner side of the U limb 25 next to the device 15. Instead or in addition, a damping compound 30 designed as an interlocking compound 32, may be inserted here near the free ends of the limbs 25; or a reversible snap-in connection 33 may be formed between the U yoke 29 and the device 15 for additional fixing of the device 15 in the frame 13.

Instead of such a snap-in connection 33, it may be more advantageous from technical aspects of production to design a damping compound 30 that is arranged at the U yoke 29 as a hook-and-loop connection 34, for simultaneous releasable holding of the device 15 pushed into the frame 13 against the yoke 29 thereof. In the case of a remote-control key as the device 15, it is finally advantageous to lock the ceramic frame 13 to the device 15 by means of the mechanical emergency key that can be pulled out from it when the emergency key has been pushed into it (not depicted).

Therefore, in order that, when a brittle ceramic element 11, such as in particular a frame 13 receiving a device 15, is destroyed, as far as possible no free fragments are detached from it, according to the invention fastening regions 16 that are integrally molded to the frame 13 are connected in a frictional or interlocking manner behind the device 15 inserted into the frame 13 to a connecting part 17 injection-molded from tough-elastic material. Said connecting part may for its part be configured at the same time for releasable fastening of the ceramic element 11 on the device 15 or on some other structural part 23.

### LIST OF DESIGNATIONS

11 ceramic element
12 control
13 frame
14 opening
15 device
16 fastening region
17 connecting part
18 holes
19 pins
20 regions; 20′, 20″
21 predetermined breaking point
22 fastening means
23 structural part
24 distance
25 limb
26 panel
27 battery holder
28 depression
29 yoke
30 damping compound
31 resilient tongue
32 interlocking compound
33 snap-in connection
34 hook-and-loop connection

1. A ceramic element designed for receiving a device and having at least one integrally formed fastening region for puntiform or linear, frictional or interlocking connection of at least one connecting part that is not ceramic and in the event of mechanical destruction of the ceramic element mechanically holds together the fragments thereof on the out-of-view side of the device in the vicinity of various mutually neighboring regions of the ceramic element that are offset from one another by predetermined breaking points that are caused by the structural design or specifically specified.

2. The ceramic element as claimed in claim 1, characterized in that herein the connecting part is designed for engaging with pins in the fastening region.

3. The ceramic element as claimed in claim 1, wherein the connecting part is designed for engaging with fastening means in a carrying structural part.

4. The ceramic element as claimed in claim 1, wherein the fastening region is designed with holes for engagement of the connecting part by means of pins, which protrude through the fastening region and engage as fastening means between the ceramic element and the device or between the ceramic element and the carrying structural part in the latter.

5. The ceramic element as claimed in claim 1, wherein it has a closed or open frame, the opening of which is spanned by a panel, integrally formed in the form of a ring or mesh or over the full surface area, as a fastening region.

6. The ceramic element as claimed in claim 5, wherein the device is lowered or pushed into the frame in front of the panel, and in that the connecting part is lowered into the frame behind the panel.

7. The ceramic element as claimed in claim 5, wherein predetermined breaking points are provided, delimiting the frame regions together with the fastening regions adjoining them from one another, which are connected to one another by way of the at least one connecting part.

8. The ceramic element as claimed in claim 1, wherein it is fitted out with the device with a clear distance, which is locally bridged by damping compounds or resilient tongues.

9. The ceramic element as claimed in claim 8, wherein a damping compound situated between the yoke of a u-shaped frame and the neighboring device is designed as a hook-and-loop connection.

10. The ceramic element as claimed in claim 9, wherein a snap-in connection is formed between the region of the yoke of a u-shaped frame and the neighboring region of the device.

11. The ceramic element as claimed in claim 1, wherein the device is fitted out with a display or with switches.

12. The ceramic element as claimed in wherein the device is a remote-control key for a motor vehicle.
